(19) United States
(12) Patent Application Publication
(10) Pub. No.: US 2023/0221864 A1
(43) Pub. Date: Jul. 13, 2023

(54) EFFICIENT INLINE BLOCK-LEVEL DEDUPLICATION USING A BLOOM FILTER AND A SMALL IN-MEMORY DEDUPLICATION HASH TABLE

(71) Applicant: VMware, Inc., Palo Alto, CA (US)

(72) Inventors: Abhay Kumar JAIN, Cupertino, CA (US); Wenguang WANG, Santa Clara, CA (US)

(21) Appl. No.: 17/647,530

(22) Filed: Jan. 10, 2022

(51) Int. Cl. G06F 3/06

(52) U.S. Cl. CPC G06F 3/0608; G06F 3/0652; G06F 3/0679

(57) ABSTRACT

A method for inline block-level deduplication is provided. The method generally includes receiving an input/output (I/O) to write a first data block in storage as associated with an logical block address (LBA), hashing the first data block to a first hash, determining a match for the first hash is contained in a bloom filter based on set bits in the bloom filter for the first hash, determining an entry for the first data block is contained in a deduplication hash table based on a subset of bits of the first hash, locating a first middle map extent in a middle map based on a middle block address (MBA) included in the entry, verifying the first hash matches the first hash stored in the middle map extent, adding a logical map extent for the LBA to a logical map, wherein the logical map extent maps the LBA to the MBA.

### BACKGROUND

The amount of data worldwide grows each year at a rate that is faster than the price drop of storage devices. Thus, the total cost of storing data continues to increase. As a result, it is increasingly important to develop and improve data efficiency techniques, such as deduplication for file and storage systems.

Data deduplication is a technique for eliminating duplicated or redundant data. Successful implementation of data deduplication techniques can improve storage utilization, which may in turn lower capital expenditure by reducing the overall amount of storage required to meet storage capacity needs. For example, the implementation of data deduplication techniques may result in approximately 1.5 to 2 times the savings of available storage space (and storage costs) given an average workload. Additionally, data deduplication techniques may improve the ability of a system to store and manage data while consuming the least amount of space on disk with little to no impact on performance. Accordingly, in some cases, overall system efficiency may be improved where data deduplication techniques are implemented.

Data deduplication works by calculating a fingerprint (e.g., using a hashing function) for each data unit and then storing units with the same fingerprint only once. In other words, data deduplication techniques rely on fingerprints of earlier seen data units, generally stored in memory, to work. However, the overhead of storing such fingerprints in memory may be prohibitively expensive, especially for larger storage systems. In particular, the cost of storing and managing fingerprints increases in proportion to the amount of data being stored. Thus, where memory resources are insufficient to store fingerprints for all data units, one or more fingerprints may be stored on disk. In particular, the operating system (OS) may move pages of memory, including such fingerprints, to disk storage to free up memory for other processes. As used herein, a page refers to an amount of data, which may be stored in memory. In certain aspects, a page may refer to the smallest unit of memory for which certain I/O can be performed. In certain aspects, a page may refer to a block of data, or a plurality of blocks of data. In certain aspects, a page has a fixed length.

Memory, and more specifically, random access memory (RAM) refers to the component which allows for short-term data access. RAM may be used to store programs and/or data that is needed in real time; however, RAM data is volatile and is erased once the system is switched off. Whereas memory refers to the location of short-term data, disk storage is the component that allows for the storage and access of data on a long-term basis. Typically, disk storage may include combinations of solid state drives (SSDs) or non-volatile memory express (NVMe) drives, magnetic or spinning disks or slower/cheaper SSDs, or other types of storages.

Accordingly, where fingerprints are stored on disk, a lookup of a fingerprint for deduplication purposes may require the OS to determine the location of the fingerprint on disk, obtain an empty page frame in RAM to use as a container for the data, and load the requested data into the available page. Further, given the random nature of fingerprints, each new data unit received for deduplication may require another page to be loaded from the disk to determine whether a fingerprint of the data unit matches a fingerprint maintained on the disk. Loading a new page in memory usually also means transferring out of memory another page back to the disk. Consistent introduction and removal of pages in memory may be costly, and thus, adversely affect the overall deduplication system.

Accordingly, there is a need in the art for improved techniques for data deduplication. In particular, there is a need for reducing or eliminating costs associated with storing and retrieving fingerprints for deduplication.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1A is a diagram illustrating an example computing environment in which embodiments of the present application may be practiced.

FIG. 1B is a diagram illustrating example buckets and entries in small, in-memory deduplication hash table, according to an example embodiment of the present disclosure.

FIG. 2 is a diagram illustrating an example two-layer extent mapping architecture, according to an example embodiment of the present disclosure.

FIG. 3 is an example workflow for inline block-level deduplication using a bloom filter and the small, in-memory deduplication hash table, according to an example embodiment of the present application.

FIG. 4 is an example workflow for the eviction of entries maintained in the deduplication hash table structure, according to an example embodiment of the present application.

FIG. 5 is an example workflow for populating entries in the deduplication hash table structure, according to an example embodiment of the present application.

FIG. 6 is an example workflow for the eviction and recovery of entries maintained in the bloom filter, according to an example embodiment of the present application.

### DETAILED DESCRIPTION

Aspects of the present disclosure introduce techniques for efficient inline deduplication using a both a bloom filter and a small (e.g., approximately one-eighth the size of the bloom filter) in-memory deduplication hash table (interchangeably referred to herein as “dedup hash table”). Inline deduplication refers to deduplication which eliminates the redundancy of data in the write path before such data is written to a disk for storage. In particular, for any new block of data (e.g., 4096 bytes or “4K” size blocks) that is being written, inline deduplication checks whether a previous block of data already exists (is stored) on the disk with a hash (interchangeably referred to herein as a “fingerprint”) matching a hash of the new block of data to be written prior to writing the new block of data to the disk, to avoid storage of duplicated data. In particular, as the hash of the block of data is a hash of the content of the block, two blocks of data with the same content will have the same hash, since the same hashing algorithm is used to calculate the hash of each of the blocks of data.

According to aspects described herein, a bloom filter and a dedup hash table (e.g., both maintained in memory) may be used to determine whether such a hash match exists. In particular, a bloom filter is a space-efficient, probabilistic data structure used to determine whether an element is present in a set. Instead of holding, in memory, hashes for every data block requested to be written, the bloom filter sets one or more bits to compactly represent such hash values. The bloom filter is said to be “probabilistic” as it involves a form of approximation which means that the bloom filter is configured to answer whether bits in the bloom filter have been set for the hash; however, some level of uncertainty is inherent in this response (e.g., this is the cost paid for the space optimization offered by the bloom filter). For example, the bloom filter may say with certainty that bits in the bloom filter have not been set for a particular hash, but the bloom filter may not say with certainty that bits in the bloom filter have been set for another hash (i.e., the bloom filter may provide a “false positive”).

The dedup hash table is a small, in-memory structure used to maintain only a subset of bits (e.g., also referred to herein as “partial hashes”) for prospective deduplicable hashes or hashes which have been deduplicated. As used herein, an entry in the dedup hash table which includes such a partial hash may be considered a prospective deduplicable hash table entry or a real deduplicable hash table entry. A prospective deduplicable hash may be a hash likely or expected to be used at a later time for deduplication of an incoming block of data requested to be written to storage. In certain aspects, a hash may be determined to be a hash likely or expected to be used at a later time for deduplication when a match for the hash is found in the bloom filter (e.g., the bloom filter returns a value of “true”). For example, a “prospective deduplicable hash” may refer to a hash of a block of data that has previously been written and stored (e.g., in memory, and potentially persisted to storage), but only corresponds to one logical block address (LBA). In contrast, a deduplicated hash may be a hash for a block of data that has previously been deduplicated. For example, a “deduplicated hash” may refer to a hash of a block of data that has previously been written and stored (e.g., in memory, and potentially persisted to storage), and corresponds to a plurality of LBAs. Accordingly, the dedup hash table may efficiently utilize memory resources by only storing prospective deduplicable hashes and/or deduplicated hashes and only storing a subset of bits for each of these hashes (e.g., partial hashes), as compared to storing full hashes for each unique block of data. In other words, the dedup hash table eliminates the need to store partial hashes for other blocks and data. Instead, the bloom filter may set bits for hashes of such blocks in a storage efficient manner in memory and allow for filtering of hashes for these blocks at very low computation and memory cost.

Further, according to certain aspects described herein, only hashes for deduplicated blocks of data and prospective deduplicable hashes (e.g., for data blocks with a hash match in the bloom filter and for “anchor” data blocks as further described herein) may be maintained in metadata in storage. As described in more detail below, metadata for each data block written to disk storage may be maintained in a two-layer data block (e.g., extent) mapping architecture, where an extent is a specific number of contiguous data blocks allocated for storing information. The first layer of the two-layer mapping architecture may include a logical map, while the second layer includes a middle map. In the logical map, instead of a logical block address (LBA) of a data block being mapped directly to a physical block address (PBA), LBA(s) of data block(s) are mapped to a middle block address (MBA) of the middle map. The middle map then maps the MBA to the PBA where the data block is written. Accordingly, as part of a data block write operation, either (1) a new logical map extent and a new middle map extent with a new MBA is created where the new logical map extent is mapped to the new middle map extent which is further mapped to the PBA where the new data block has been written or (2) a new logical map extent is created and mapped to an existing middle map extent pointing to a PBA where the data block content has prior been written.

Techniques herein propose storing hashes (e.g., and associated reference counts indicating a number of times a data block is deduplicated) in middle map extents. The extents in the middle map may be updated with the hashes and reference counts as part of the regular write operation. Each hash stored in a middle map extent may be a hash of the data block associated with a PBA the middle map extent is mapped to. By leveraging the existing write to the middle map to further store hash values associated with data blocks, no additional lookup cost is incurred for deduplication to locate a hash for comparison.

As described in more detail below, the techniques for setting bits in the bloom filter in memory, storing partial hashes of prospective deduplicable blocks of data and deduplicated blocks of data in the dedup hash table in memory, and maintaining full hash values (e.g., for prospective deduplicable blocks of data, deduplicated blocks of data, and “anchor” blocks of data) in a middle map in storage may provide many advantages, which may lead to overall improvement in data deduplication techniques. Such advantages may include, but may not be limited to, a reduced memory footprint, reduced input/output (I/O) costs to store and locate hash values for deduplication, and the preservation of the locality of deduplicated data blocks.

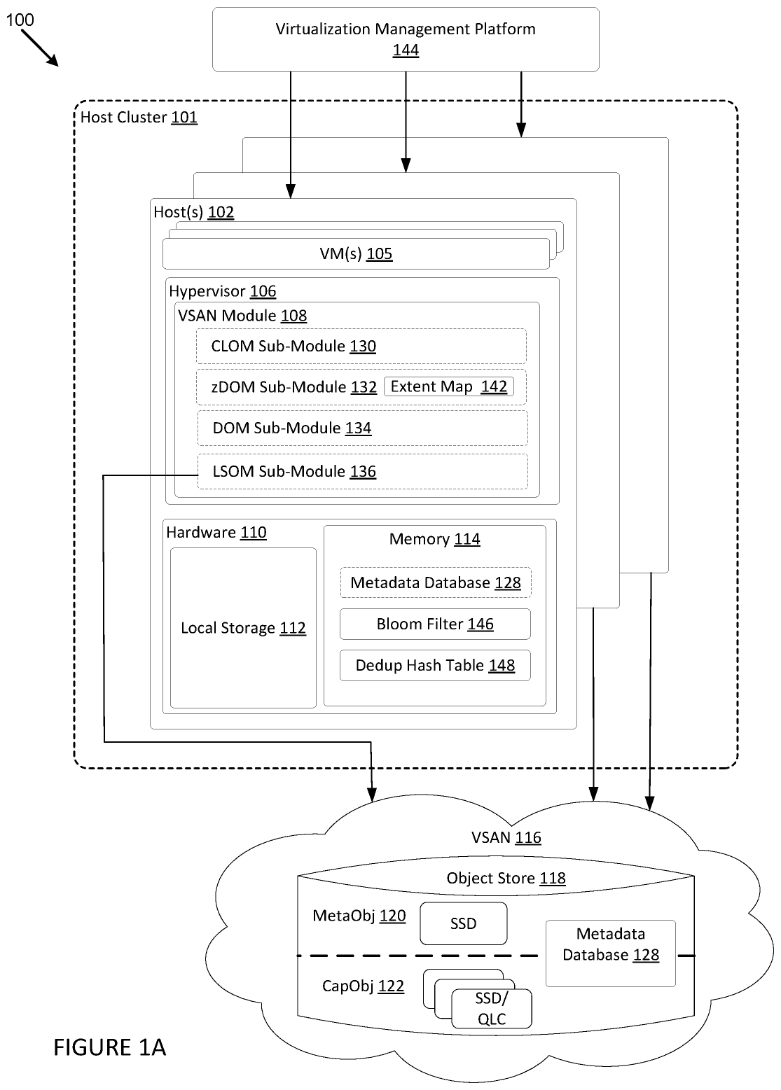

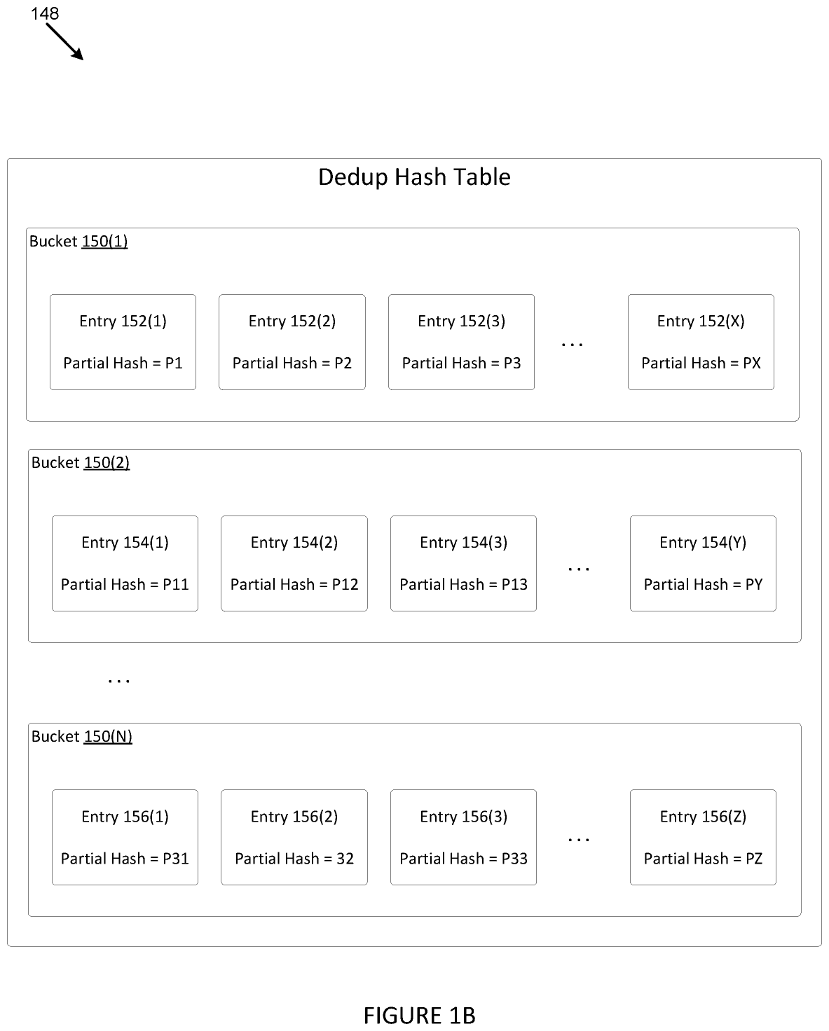

FIG. 1A is a diagram illustrating an example computing environment 100 in which embodiments may be practiced. As shown, computing environment 100 may include a distributed object-based datastore, such as a software-based “virtual storage area network” (VSAN) environment, VSAN 116, that leverages the commodity local storage housed in or directly attached (hereinafter, use of the term “housed” or “housed in” may be used to encompass both housed in or otherwise directly attached) to host(s) 102 of a host cluster 101 to provide an aggregate object storage to virtual machines (VMs) 105 running on the host(s) 102. The local commodity storage housed in the hosts 102 may include combinations of solid state drives (SSDs) or non-volatile memory express (NVMe) drives, magnetic or spinning disks or slower/cheaper SSDs, or other types of storages.

Additional details of VSAN are described in U.S. Pat. No. 10,509,708, the entire contents of which are incorporated by reference herein for all purposes, and U.S. patent application Ser. No. 17/181,476, the entire contents of which are incorporated by reference herein for all purposes.

As described herein, VSAN 116 is configured to store virtual disks of VMs 105 as data blocks in a number of physical blocks, each physical block having a PBA that indexes the physical block in storage. VSAN module 108 may create an “object” for a specified data block by backing it with physical storage resources of an object store 118 (e.g., based on a defined policy).

VSAN 116 may be a two-tier datastore, storing the data blocks in both a smaller, but faster, performance tier and a larger, but slower, capacity tier. The data in the performance tier may be stored in a first object (e.g., a data log that may also be referred to as a MetaObj 120) and when the size of data reaches a threshold, the data may be written to the capacity tier (e.g., in full stripes, as described herein) in a second object (e.g., CapObj 122) in the capacity tier. SSDs may serve as a read cache and/or write buffer in the performance tier in front of slower/cheaper SSDs (or magnetic disks) in the capacity tier to enhance I/O performance. In some embodiments, both performance and capacity tiers may leverage the same type of storage (e.g., SSDs) for storing the data and performing the read/write operations. Additionally, SSDs may include different types of SSDs that may be used in different tiers in some embodiments. For example, the data in the performance tier may be written on a single-level cell (SLC) type of SSD, while the capacity tier may use a quad-level cell (QLC) type of SSD for storing the data.

Each host 102 may include a storage management module (referred to herein as a VSAN module 108) in order to automate storage management workflows (e.g., create objects in MetaObj 120 and CapObj 122 of VSAN 116, etc.) and provide access to objects (e.g., handle I/O operations to objects in MetaObj 120 and CapObj 122 of VSAN 116, etc.) based on predefined storage policies specified for objects in object store 118.

In certain embodiments, VSAN module 108 is configured to eliminate duplicated or redundant data in the write I/O path prior to the data being written to one or more objects in VSAN 116, according to certain aspects described herein. In particular, in some cases, VSAN module 108 services a write I/O request using a bloom filter 146 and/or a dedup hash table 148 maintained in memory 114 to ensure data blocks with a same hash value are stored only once. Where VSAN module 108 determines a hash of a data block to be written matches a hash of a data block previously written to VSAN 116, VSAN module 108 may map an LBA of the requested data block to an MBA mapped to the PBA of a physical block where the data has previously been stored, instead of writing the duplicated data to a new physical block. Accordingly, highly deduplicated data may be referenced by multiple LBAs. In other words, the greater the number of LBAs referencing the same data, the greater the level of deduplication.

In certain embodiments, VSAN module 108 first checks bloom filter 146 to determine whether a hash of a data block to be written likely/probably matches a hash of a data block previously written to VSAN 116 (e.g., first check bloom filter 146 to determine whether the data block to be written probably contains duplicated data). Bloom filter 146 is a probabilistic space-efficient data structure maintained in memory 114 which comprises a bit array of m bits initialized to zero. Bloom filter 146 may support two operations: test operations and add operations. In particular, test operations may be used to check whether bits of the hash of the data block to be written have been previously set. Where the bloom filter returns a value of “false”, then the hash is not in the bloom filter (e.g., bits for the hash have not previously been set) and the data block is not considered to be duplicated data. On the other hand, where the bloom filter returns a value of “true”, then the hash is “probably” in the bloom filter (e.g., bits for the hash are likely to have been previously set) and the data block is considered to be duplicated data. In such a case, where a value of “true” is returned, VSAN module 108 may then further look for one or more bits of the hash in dedup hash table 148 to further confirm that this data block contains duplicated data.

Alternatively, add operations may be used to add a hash to the bloom filter where the bloom filter returns a value of “false”. In other words, add operations may be used to set bits for the hash of the data block requested to be written to VSAN 116 where it is determined that the hash for this data block is unique (e.g., bits for the hash have not been previously set in bloom filter 146). In certain embodiments, to set bits for the hash of the data block, the hash is fed to k hash functions to get k array positions (e.g., in an m bit array of m bits initialized to zero) and the bits at these k array positions are set to 1, where k is an integer greater than or equal to one.

As an illustrative example, adding a hash entry into bloom filter 146 with k=3 hash functions includes setting three bits in the bit array for the hash entry equal to one. Accordingly, at a subsequent time when VSAN module 108 determines whether bits of a hash of the data block to be written have been previously set, VSAN module 108 feeds the hash to be searched to k=3 hash functions to obtain k=3 array positions. If any of the bits at these three array positions are zero (e.g., instead of being set to 1), then the hash is determined not to be in bloom filter 146. Alternatively, if the bits at each of the three array positions are set to one, then VSAN module 108 determines the hash entry “might” be in bloom filter 146.

As mentioned, where a value of “true” is returned by bloom filter 146, VSAN module 108 may further look for one or more bits of the hash in dedup hash table 148 to further confirm that this data block contains duplicated data. In certain aspects, dedup hash table 148 is maintained in memory 114 and is not persisted. Dedup hash table 148 maintains a mapping of an MBA to a partial hash associated with a data block stored in a PBA associated with the MBA. As described in more detail below, MBAs are mapped to PBAs of physical blocks where data blocks are written in VSAN 116. The partial hash maintained in dedup hash table 148 correspond to a subset of bits (e.g., one or more bits) of a hash associated with a data block for which the MBA is mapped to.

In certain embodiments, dedup hash table 148 further includes a match bit which is set for prospective deduplicable entries added to dedup hash table 148 based on finding a match for the hashes associated with the entries in bloom filter 146 or deduplicated entries (e.g., entries which have been previously deduplicated). Other prospective deduplicable entries added to dedup hash table 148 not based on finding a match for the hash associated with entries in dedup hash table 148 are considered “anchor” entries. “Anchor” entries in dedup hash table 148 may be added to dedup hash table 148 based on a previously-set policy (e.g., such a policy could indicate to add every eighth or sixteenth data block to be written as an anchor entry to dedup hash table 148). Adding “anchor” entries in dedup hash table 148 may be used to increase the likelihood of determining a data block to be written includes data which has previously been written (e.g., contains duplicated data). “Anchor” entries are added to dedup hash table 148 without a match bit set.

In certain embodiments, dedup hash table 148 further includes a reference bit that is set when a data block requested to be written gets deduplicated against the entry in dedup hash table 148. Accordingly, in certain embodiments, an entry in dedup hash table 148 contains a tuple of <MBA, Partial Hash, Match Bit, Reference Bit>.

Further, in certain embodiments, dedup hash table 148 is separated into buckets, where each bucket corresponds to a subset of bits for one or more hash values. In particular, buckets may store one or more dedup hash table 148 entries and be based on a subset of bits (e.g., one or more bits) of the hash value for each entry in the bucket. The subset of bits for the buckets in hash table 148 may be a smaller subset of bits than the subset of bits corresponding to a partial hash. As such, one or more partial hashes may have a common subset of bits corresponding to a bucket in dedup hash table 148. As an illustrative example, a hash for a data block may be a 64-bit hash. When adding an entry in dedup hash table 148 for this data block, a first subset of bits of the hash, for example, 16 bits of the hash may be used to locate a bucket in dedup hash table 148 with the same 16 bits. The entry for this data block added in this identified bucket, may be stored with a partial hash, or a second subset of bits of the hash, for example, 32 bits of the hash (e.g., including or not including one or more bits of the 16 bits of the hash used to locate the bucket).

FIG. 1B is a diagram illustrating example buckets and entries in deduplication hash table 148, according to an example embodiment of the present disclosure. As shown in deduplication hash table 148, buckets 150(1)-150(N) (individually referred to herein as bucket 150 and collectively referred to herein as buckets 150) may be used to store one or more dedup hash table 148 entries.

Entries 152(1)-152(X) (individually referred to herein as entry 152 and collectively referred to herein as entries 152) in bucket 150(1) may correspond to data blocks with hashes that have a first common subset of bits. For example, where bucket 150(1) is created using 8 bits, 8 bits of a hash associated with entry 152(1) match the 8 bits used to create bucket 150(1), 8 bits of a hash associated with entry 152(2) match the 8 bits used to create bucket 150(1), 8 bits of a hash associated with entry 152(3) match the 8 bits used to create bucket 150(1), etc.

Further, a partial hash may be stored for each entry 152 in bucket 150(1). A partial hash stored for an entry 152 may be different than partial hashes stored for other entries 152 in bucket 150(1) (e.g., P1≠P2≠P3 . . . etc.). The partial hash for each entry 152 may correspond to a second subset of bits of a hash for a data block associated with each entry 152. In certain embodiments, the second subset of bits for the hash may be a greater number of bits of the hash than the first common subset of bits. For example, where the hash for a data block associated with entry 152(1) is 32-bits and 8 bits of the 32 bits are used to find bucket 150(1), 16 bits of the 32 bits may be used to represent the partial hash stored in entry 152(1). The 16 bits may not include the one or more bits of the 8 bits used to locate the bucket.

Similarly, entries 154(1)-152(Y) (individually referred to herein as entry 154 and collectively referred to herein as entries 154) in bucket 150(2) may correspond to data blocks with hashes that have a second common subset of bits, where the first common set of bits for bucket 150(1) is different than the second common subset of bits for bucket 150(2). For example, where bucket 150(2) is also created using 8 bits, 8 bits of a hash associated with entry 154(1) match the 8 bits used to create bucket 150(2), 8 bits of a hash associated with entry 154(2) match the 8 bits used to create bucket 150(2), 8 bits of a hash associated with entry 154(3) match the 8 bits used to create bucket 150(3), etc.

Further, a partial hash may be stored for each entry 154 in bucket 150(2). A partial hash stored for an entry 154 may be different than partial hashes stored for other entries 154 in bucket 150(2) (e.g., P11≠P12≠P13 . . . etc.). The partial hash for each entry 154 may correspond to a second subset of bits of a hash for a data block associated with each entry 154.

Accordingly, entries in each bucket 150 in _{dedup} hash table 148 may correspond to data blocks with hashes that have a common subset of bits, where a common set of bits for entries in a bucket 150 is different than a common subset of bits for entries in another bucket 150. Further, a partial hash stored for each entry in each bucket 150 may be different than partial hashes stored for other entries in the bucket 150 (as well as different than partial hashes store for other entries in other buckets 150).

Buckets 150 may be configured to maintain a threshold amount of entries. For example, entry 152(X) may be an x-th entry within the threshold amount of entries configured for bucket 150(1), and entry 154(Y) may be the y-th entry within the threshold amount of entries configured for bucket 150(2). In certain aspects, a threshold amount of entries configured for each bucket is the same.

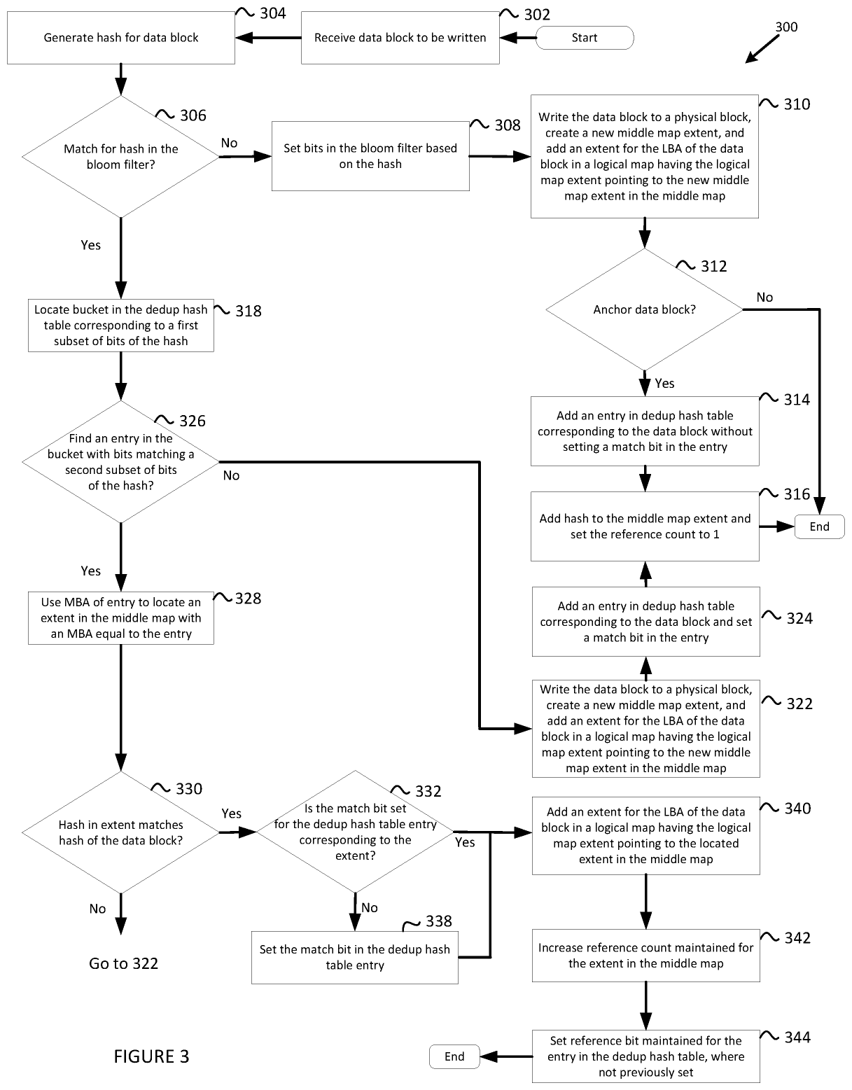

The bucket organization of dedup hash table 148 may be used to efficiently lookup dedup hash table entries to locate matching hashes, as described in more detail below with respect to FIG. 3.

Because dedup hash table 148 contains only prospective deduplicable entries or deduplicated entries, dedup hash table 148 may be considered to be small compared to bloom filter 148 and compared to a dedup hash table containing hashes of every block of data.

Referring back to FIG. 1A, a virtualization management platform 144 is associated with host cluster 101. Virtualization management platform 144 enables an administrator to manage the configuration and spawning of VMs 105 on various hosts 102. As illustrated in FIG. 1, each host 102 includes a virtualization layer or hypervisor 106, a VSAN module 108, and hardware 110 (which includes the storage (e.g., SSDs) of a host 102). Through hypervisor 106, a host 102 is able to launch and run multiple VMs 105. Hypervisor 106, in part, manages hardware 110 to properly allocate computing resources (e.g., processing power, random access memory (RAM), etc.) for each VM 105. Each hypervisor 106, through its corresponding VSAN module 108, provides access to storage resources located in hardware 110 (e.g., storage) for use as storage for virtual disks (or portions thereof) and other related files that may be accessed by any VM 105 residing in any of hosts 102 in host cluster 101.

VSAN module 108 may be implemented as a “VSAN” device driver within hypervisor 106. In such an embodiment, VSAN module 108 may provide access to a conceptual “VSAN” through which an administrator can create a number of top-level “device” or namespace objects that are backed by object store 118 of VSAN 116. By accessing application programming interfaces (APIs) exposed by VSAN module 108, hypervisor 106 may determine all the top-level file system objects (or other types of top-level device objects) currently residing in VSAN 116.

Each VSAN module 108 (through a cluster level object management or “CLOM” sub-module 130) may communicate with other VSAN modules 108 of other hosts 102 to create and maintain an in-memory metadata database 128 (e.g., maintained separately but in synchronized fashion in memory 114 of each host 102) that may contain metadata describing the locations, configurations, policies and relationships among the various objects stored in VSAN 116. Specifically, in-memory metadata database 128 may serve as a directory service that maintains a physical inventory of VSAN 116 environment, such as the various hosts 102, the storage resources in hosts 102 (e.g., SSD, NVMe drives, magnetic disks, etc.) housed therein, and the characteristics/capabilities thereof, the current state of hosts 102 and their corresponding storage resources, network paths among hosts 102, and the like. In-memory metadata database 128 may further provide a catalog of metadata for objects stored in MetaObj 120 and CapObj 122 of VSAN 116 (e.g., what virtual disk objects exist, what component objects belong to what virtual disk objects, which hosts 102 serve as “coordinators” or “owners” that control access to which objects, quality of service requirements for each object, object configurations, the mapping of objects to physical storage locations, etc.).

In-memory metadata database 128 is used by VSAN module 108 on host 102, for example, when a user (e.g., an administrator) first creates a virtual disk for VM 105 as well as when VM 105 is running and performing I/O operations (e.g., read or write) on the virtual disk.

VSAN module 108, by querying its local copy of in-memory metadata database 128, may be able to identify a particular file system object (e.g., a virtual machine file system (VMFS) file system object) stored in object store 118 that may store a descriptor file for the virtual disk. The descriptor file may include a reference to a virtual disk object that is separately stored in object store 118 of VSAN 116 and conceptually represents the virtual disk (also referred to herein as composite object). The virtual disk object may store metadata describing a storage organization or configuration for the virtual disk (sometimes referred to herein as a virtual disk “blueprint”) that suits the storage requirements or service level agreements (SLAs) in a corresponding storage profile or policy (e.g., capacity, availability, IOPs, etc.) generated by a user (e.g., an administrator) when creating the virtual disk.

The metadata accessible by VSAN module 108 in in-memory metadata database 128 for each virtual disk object provides a mapping to or otherwise identifies a particular host 102 in host cluster 101 that houses the physical storage resources (e.g., slower/cheaper SSDs, magnetics disks, etc.) that actually stores the physical disk of host 102.

Various sub-modules of VSAN module 108, including, in some embodiments, CLOM sub-module 130, distributed object manager (DOM) sub-module 134, zDOM sub-module 132, and/or local storage object manager (LSOM) sub-module 136, handle different responsibilities. CLOM sub-module 130 generates virtual disk blueprints during creation of a virtual disk by a user (e.g., an administrator) and ensures that objects created for such virtual disk blueprints are configured to meet storage profile or policy requirements set by the user. In addition to being accessed during object creation (e.g., for virtual disks), CLOM sub-module 130 may also be accessed (e.g., to dynamically revise or otherwise update a virtual disk blueprint or the mappings of the virtual disk blueprint to actual physical storage in object store 118) on a change made by a user to the storage profile or policy relating to an object or when changes to the cluster or workload result in an object being out of compliance with a current storage profile or policy.

In one embodiment, if a user creates a storage profile or policy for a virtual disk object, CLOM sub-module 130 applies a variety of heuristics and/or distributed algorithms to generate a virtual disk blueprint that describes a configuration in host cluster 101 that meets or otherwise suits a storage policy. The storage policy may define attributes such as a failure tolerance, which defines the number of host and device failures that a VM can tolerate. A redundant array of inexpensive disks (RAID) configuration may be defined to achieve desired redundancy through mirroring and access performance through erasure coding (EC). EC is a method of data protection in which each copy of a virtual disk object is partitioned into stripes, expanded and encoded with redundant data pieces, and stored across different hosts 102 of VSAN 116 datastore. For example, a virtual disk blueprint may describe a RAID 1 configuration with two mirrored copies of the virtual disk (e.g., mirrors) where each are further striped in a RAID 0 configuration. Each stripe may contain a plurality of data blocks (e.g., four data blocks in a first stripe). Including RAID 5 and RAID 6 configurations, each stripe may also include one or more parity blocks. Accordingly, CLOM sub-module 130, may be responsible for generating a virtual disk blueprint describing a RAID configuration.

CLOM sub-module 130 may communicate the blueprint to its corresponding DOM sub-module 134, for example, through zDOM sub-module 132. DOM sub-module 134 may interact with objects in VSAN 116 to implement the blueprint by allocating or otherwise mapping component objects of the virtual disk object to physical storage locations within various hosts 102 of host cluster 101. DOM sub-module 134 may also access in-memory metadata database 128 to determine the hosts 102 that store the component objects of a corresponding virtual disk object and the paths by which those hosts 102 are reachable in order to satisfy the I/O operation. Some or all of metadata database 128 (e.g., the mapping of the object to physical storage locations, etc.) may be stored with the virtual disk object in object store 118.

When handling an I/O operation from VM 105, due to the hierarchical nature of virtual disk objects in certain embodiments, DOM sub-module 134 may further communicate across the network (e.g., a local area network (LAN), or a wide area network (WAN)) with a different DOM sub-module 134 in a second host 102 (or hosts 102) that serves as the coordinator for the particular virtual disk object that is stored in local storage 112 of the second host 102 (or hosts 102) and which is the portion of the virtual disk that is subject to the I/O operation. If VM 105 issuing the I/O operation resides on a host 102 that is also different from the coordinator of the virtual disk object, DOM sub-module 134 of host 102 running VM 105 may also communicate across the network (e.g., LAN or WAN) with the DOM sub-module 134 of the coordinator. DOM sub-modules 134 may also similarly communicate amongst one another during object creation (and/or modification).

Each DOM sub-module 134 may create their respective objects, allocate local storage 112 to such objects, and advertise their objects in order to update in-memory metadata database 128 with metadata regarding the object. In order to perform such operations, DOM sub-module 134 may interact with a local storage object manager (LSOM) sub-module 136 that serves as the component in VSAN module 108 that may actually drive communication with the local SSDs (and, in some cases, magnetic disks) of its host 102. In addition to allocating local storage 112 for virtual disk objects (as well as storing other metadata, such as policies and configurations for composite objects for which its node serves as coordinator, etc.), LSOM sub-module 136 may additionally monitor the flow of I/O operations to local storage 112 of its host 102, for example, to report whether a storage resource is congested.

zDOM sub-module 132 may be responsible for caching received data in the performance tier of VSAN 116 (e.g., as a virtual disk object in MetaObj 120) and writing the cached data as full stripes on one or more disks (e.g., as virtual disk objects in CapObj 122). To reduce I/O overhead during write operations to the capacity tier, zDOM may require a full stripe (also referred to herein as a full segment) before writing the data to the capacity tier. Data striping is the technique of segmenting logically sequential data, such as the virtual disk. Each stripe may contain a plurality of data blocks; thus, a full stripe write may refer to a write of data blocks that fill a whole stripe. A full stripe write operation may be more efficient compared to the partial stripe write, thereby increasing overall I/O performance. For example, zDOM sub-module 132 may do this full stripe writing to minimize a write amplification effect. Write amplification, refers to the phenomenon that occurs in, for example, SSDs, in which the amount of data written to the memory device is greater than the amount of information you requested to be stored by host 102. Write amplification may differ in different types of writes. Lower write amplification may increase performance and lifespan of an SSD.

In some embodiments, zDOM sub-module 132 performs other datastore procedures, such as data compression and hash calculation, which may result in substantial improvements, for example, in garbage collection, deduplication, snapshotting, etc. (some of which may be performed locally by LSOM sub-module 136 of FIG. 1).

In some embodiments, zDOM sub-module 132 stores and accesses an extent map 142. Extent map 142 provides a mapping of LBAs to PBAs, or LBAs to MBAs to PB As. Each physical block having a corresponding PBA may be referenced by one or more LBAs.

In certain embodiments, for each LBA, VSAN module 108, may store in a logical map of extent map 142, at least a corresponding PBA. The logical map may include an LBA to PBA mapping table. For example, the logical map may store tuples of <LBA, PBA>, where the LBA is the key and the PBA is the value. As used herein, a key is an identifier of data and a value is either the data itself or a pointer to a location (e.g., on disk) of the data associated with the identifier. In some embodiments, the logical map further includes a number of corresponding data blocks stored at a physical address that starts from the PBA (e.g., tuples of <LBA, PBA, number of blocks>, where LBA is the key). In some embodiments where the data blocks are compressed, the logical map further includes the size of each data block compressed in sectors and a compression size (e.g., tuples of <LBA, PBA, number of blocks, number of sectors, compression size>, where LBA is the key).

In certain other embodiments, for each LBA, VSAN module 108, may store in a logical map, at least a corresponding MBA, which further maps to a PBA in a middle map of extent map 142. In other words, metadata for each data block written to disk storage may be maintained in a two-layer extent mapping architecture, where the first layer of the two-layer mapping architecture is the logical map, while the second layer includes the middle map. As discussed above, VSAN module 108 may further store a hash and a reference count in middle map extents for deduplicated blocks of data and prospective deduplicable blocks of data.

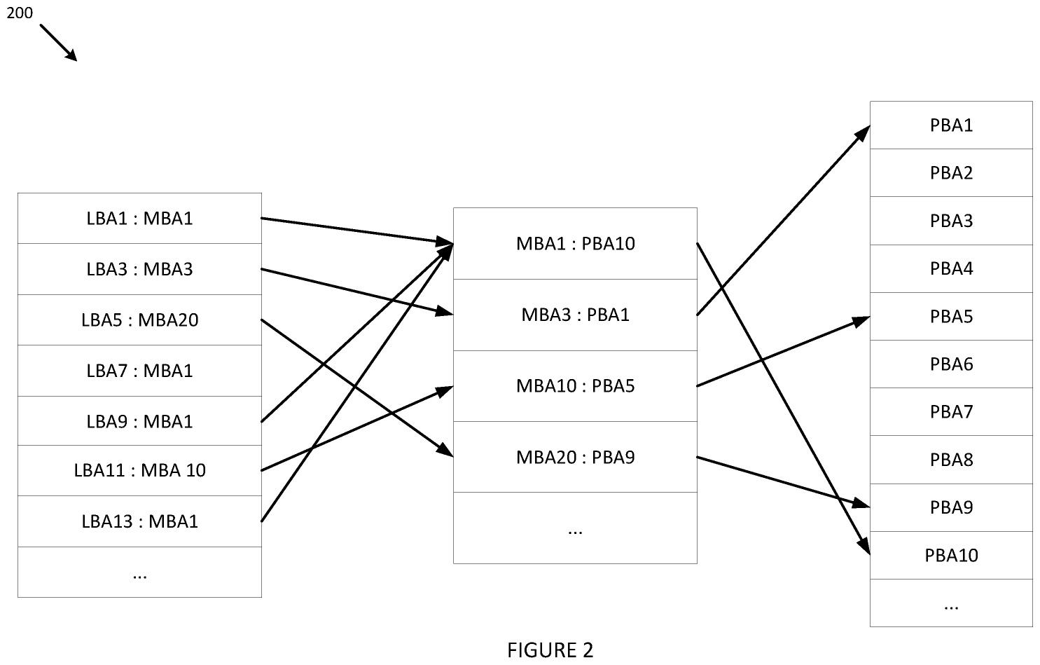

FIG. 2 is a diagram 200 illustrating an example two-layer extent mapping architecture, according to an example embodiment of the present disclosure. As shown in FIG. 2, the first layer of the two-layer extent mapping architecture includes a logical map, and the schema of the logical map may store a one tuple key <LBA> to a two-tuple value <MBA, numBlocks>. In some embodiments, other tuple values, such as a number of sectors, compression size, etc. may also be stored in the logical map. Because a middle map extent may refer to a number of contiguous blocks, value “numBlocks” may indicate a number of uncompressed contiguous middle map blocks for which the data is stored within.

The second layer of the two-layer extent mapping architecture includes a middle map responsible for maintaining a mapping between MBA(s) and PBA(s) (or physical sector address(es) (PSA(s)) of one or more sectors (e.g., each sector being 512-byte) of a physical block where blocks are compressed prior to storage). Accordingly, the schema of the middle map may store a one tuple key <MBA> and a two-tuple value <PBA, numBlocks>. Value “numBlocks” may indicate a number of contiguous blocks starting at the indicated PBA. Any subsequent overwrite may break the PBA contiguousness in the middle map extent, in which case an extent split may be triggered.

In certain embodiments, each physical block may be subdivided into a number of sectors (e.g., eight sectors). Accordingly, in certain embodiments each compressed data block may be stored in one or more sectors (e.g., each sector being 512 bytes) of a physical block. In such cases, the schema of the middle map may store a one tuple key <MBA> and a four-tuple value <PSA, numBlocks, numSectors, compression size>. In some embodiments, other tuple values, such as cyclic redundancy check (CRC), may also be stored in the middle map.

In the example of FIG. 2, LBA1, LBA9, and LBA13 all map to PBA10. In other words, PBA10 contains deduplicated data. Instead of mapping each of these references to the same PBA, a middle map extent may be created, and each reference points to the middle map extent specific for PBA10 (e.g., MBA1). In this case, LBA1 may be stored in a logical map as a tuple of <LBA1, MBA1>, LBA9 may be stored in the logical map as a tuple of <LBA9, MBA1>, and LBA13 may be stored in the logical map as a tuple of <LBA13, MBA1>. At the middle map, a tuple of <MBA1, PBA10> may be stored. Although not shown in FIG. 2, as discussed above, VSAN module 108 may further store a hash and a reference count in middle map extents for deduplicated blocks of data and prospective deduplicable blocks of data.

The middle map is included in the mapping architecture, such as to address the problem of I/O overhead when dynamically relocating physical data blocks for full stripe writes. In particular, to reduce I/O overhead during write operations to the capacity tier of object store 118, zDOM sub-module 132 may require a full stripe (also referred to herein as a full segment) before writing the data to the capacity tier. Because some SSDs of object store 118 may only allow write after erase operations (e.g., program/erase (P/E) cycles) and may not permit re-write operations, a number of active blocks of a stripe may be decreased. In order to provide clean stripes for full stripe writes, segment cleaning may be introduced to recycle segments partially filled with “valid” blocks (e.g., active blocks) and move such valid block(s) to new location(s) (e.g., new stripe(s)). In other words, segment cleaning consolidates fragmented free space to improve write efficiency. The dynamic relocation of valid (e.g., active) blocks to new location(s) may trigger updates to extent map 142, as well as a snapshot mapping architecture. In some cases, such updates to mapping tables of the snapshot mapping architecture may introduce severe I/O overhead. For this reason, the two-layer snapshot mapping architecture, including the middle map, may be used to address the problem of I/O overhead when dynamically relocating physical data blocks such that only a single middle map extent needs to be updated to reference a new PBA when a data block is relocated.

For example, as illustrated in FIG. 2, data block content referenced by LBA1, LBA9, and LBA13 all map to MBA1 which further maps to PBA1. If the data block content referenced by LBA1, LBA9, and LBA13 is moved from PBA10 to another PBA, for example, PBA20, due to segment cleaning for a full stripe write, only a single extent at a middle map may be updated to reflect the change of the PBA for all of the LBAs which reference that data block. In this example, a tuple for MBA1 stored at the middle map may be updated from <MBA1, PBA10> to <MBA1, PBA20>. This two-layer mapping architecture reduces I/O overhead by not requiring the system to update multiple references to the same PBA extent at different snapshot logical maps. Additionally, the two-layer extent mapping architecture removes the need to keep another data structure to find all logical map pointers pointing to a middle map extent to be updated.

Embodiments herein are described with respect to the two-layer extent mapping architecture having both a logical map and a middle map.

FIG. 3 is an example workflow 300 for inline block-level deduplication using a bloom filter and a small, in-memory deduplication hash table, according to an example embodiment of the present application. Workflow 300 may be performed by VSAN module 108 illustrated in FIG. 1, to execute inline deduplication for one or more data blocks requesting to be written to storage (e.g., VSAN 116, and more specifically, object store 118, illustrated in FIG. 1).

Workflow 300 begins, at operation 302, by VSAN module 108 receiving a data block to be written. In some cases, the data block may be one data block among a plurality of data blocks for a first payload of data requesting to be written (e.g., requested by a VM 105 illustrated in FIG. 1). The data block received at operation 302 may correspond to a size of a physical block of storage (e.g., 4096 bytes or “4K” size blocks). Further, the data block received at operation 302 may be referenced by an LBA. At operation 304, a corresponding hash is generated for the data block, for example, by using a cryptographic hashing algorithm.

At operation 306, VSAN module 108 checks whether bloom filter 146 contains a match for the hash generated at operation 304. This is the first check to determine whether the data block received at operation 302 contains duplicated data (e.g., data that has previously been written to VSAN 116). As described above, checking whether bloom filter 146 contains a match for the hash generated at operation 304 includes checking whether bits of the hash of the data block to be written have been previously set in bloom filter 146.

Where, at operation 306, VSAN module 108 determines a match for the hash is not in bloom filter 146 (e.g., a value of “false” is returned by bloom filter 146), VSAN module 108 determines the data block received at operation 302 (and corresponding to the hash) does not contain duplicated data. At operation 308, bits for the hash are set in bloom filter 146. In certain embodiments, setting the bits for the hash includes feeding the hash to k hash functions to get k array positions and setting bits at each of these k array positions to 1. The hash may be considered to be added to bloom filter 146 after bits for the hash are set in bloom filter 146.

Because this data block contains data that has not previously been written to VSAN 116, at operation 310, VSAN module 108 writes the data block to a physical block referenced by a PBA in VSAN 116. Further, VSAN module 108 creates a new middle map extent with a monotonically increased MBA and adds an extent for the LBA of the data block in a logical map. The extent in the logical map may point to the new middle map extent in the middle map.

As an illustrative example, the data block received at operation 302 may be associated with LBA15. Accordingly, using the example two-layer extent mapping architecture illustrated in FIG. 2, VSAN module 108 writes the data block for LBA15 to a physical block, for example, a physical block referenced by PBA11. Further, VSAN module 108 creates a new middle map extent for a monotonically increased MBA, for example, MBA21. The new middle map extent maintains a mapping between MBA21 and PBA11. VSAN module 108 also creates a new logical map extent for LBA15. The new logical map extent maintains a mapping between LBA15 and MBA21.

At operation 312, VSAN module 108 determines whether the data block received at operation 302 is an “anchor” data block. As described above, a policy may be set to determine whether a data block qualifies as an “anchor” data block. For example, a previously set policy may indicate that every 8th or 16th block requested to be written to VSAN 116 is an “anchor” data block. Where a data block is determined not to be an “anchor” data block, workflow 300 may be complete. However, where a data block is determined to be an “anchor” data block, additional operations 314 and 316 may be performed by VSAN module 108.

In particular, at operation 314, VSAN module 108 adds an entry in dedup hash table 148 corresponding to the data block. In certain embodiments, the entry for the data block contains a tuple of <MBA, Partial Hash, Match Bit, Reference Bit>. The MBA in the tuple may correspond to the MBA which points to the PBA where the data block was written at operation 310. For example, using the illustrative example, the MBA in the tuple would be MBA21. The partial hash in the tuple may correspond to a subset of bits (referred to herein as a “second subset of bits”) of the hash for the data block, where the subset of bits of the hash is less than all bits of the hash. In this case, the match bit in the entry may not be set. As mentioned previously, a match bit may only be set for entries in dedup hash table 148 which correspond to prospective deduplicable entries that are found in bloom filter 146 at operation 306 or deduplicated entries (e.g., entries in dedup hash table 148 which have been used for deduplication). Because this entry is added to dedup hash table 148 based on the “anchor” data block policy, as opposed to finding the data block in bloom filter 146 or based on deduplication, the match bit is not set (e.g., match bit=0). Lastly, the reference bit in the tuple may also not be set at this point. A reference bit is set for an entry when a data block requested to be written gets deduplicated against the entry in dedup hash table 148. Thus, because this entry has not been deduplicated, the reference bit is not set (e.g., reference bit=0). Accordingly, the entry for the data block may contain a tuple of <MBA21, Partial Hash, 0, 0>.

In certain embodiments, adding the entry in dedup hash table 148 includes adding the entry to a particular bucket in dedup hash table 148. Either a previously created bucket in dedup hash table 148 may be located and used for storing the entry or a new bucket may be created. In particular, to locate a bucket in dedup hash table 148 for storing the entry at operation 314, a subset of bits (referred to herein as a “first subset of bits”) of the hash of the data block is used to find a bucket with matching bits, where the subset of bits of the hash is less than all bits of the hash. In certain aspects, a bucket with “matching bits” is found when the first subset of bits of the hash having a particular order are the same bits, in the same order used to create the bucket. In certain embodiments, buckets in dedup hash table 148 have been predetermined and provisioned; thus, a bucket is expected to be located. However, in certain other embodiments, this may not be the case, thus, where an existing bucket is not found, a new bucket with this first subset of bits is created for storing the entry.

At operation 316, VSAN module 108 adds the hash (e.g., full hash) for the data block (e.g., generated at operation 304) to the middle map extent created at operation 310. For example, VSAN module 108 adds the hash for the data block to the middle map extent corresponding to MBA21. Although operation 316 is shown subsequent to operation 310 for purposes of illustration, operations 310 and 316 may be performed simultaneously such that the hash for the data block is added to the middle map extent when the middle map extent is created to avoid incurring additional I/O write costs needed to store the hash (e.g., leverage the existing write to the middle map). Further, at operation 316, a reference count in the middle map extent may be set to 1. The reference count maintained in the middle map for the middle map extent may correspond to the number of logical map extents that point to the middle map extent. In this case, only one logical map extent, the logical map extent for LBA15, points to the middle map extent. Additionally, at operation 316, the match bit for the data block is added to the middle map extent. In this case, the match bit added to the middle map extent is equal to zero.

As illustrated by operations 312-316, adding a hash and reference count for a data block to a middle map extent is only applicable for “anchor” data blocks where the data block is not found in bloom filter 146. In particular, adding a hash value for every data block not found in bloom filter 146 to extents in the middle map would result in a significant increase in the size of the middle map. However, based on storage resources, only a few hashes may be accommodated in the middle map. Accordingly, storing every hash may not be possible. Thus, only hashes for “anchor” data blocks which are not found in bloom filter 146 are added to the middle map, as opposed to a hash for every data block which is not found in bloom filter 146.

Further, storing hashes for “anchor” data blocks may improve deduplication in at least two ways. First, storing hashes for “anchor” data blocks may increase the likelihood of finding a deduplicable data block (e.g., based on its stored hash) for a subsequent I/O request to write a data block to VSAN 116. Second, hashes stored for “anchor” data blocks may be useful in determining whether neighboring (e.g., adjacent) middle map extents to a middle map extent having a hash which is determined to match a hash for a data block requested to be written (e.g., is determined to be a deduplicated hash/data block) are also deduplicated hashes. The assumption is that each data block of a large payload that is requested to be written to VSAN 116 may have a similar deduplication property. For example, a payload requested to be written may be separated into five 4K data blocks (e.g., DB1, DB2, DB3, DB4, and DB5). Where DB1 is determined to be duplicated data, it may be assumed that DB2, DB3, DB4, and DB5 also contain duplicated data. To confirm this assumption, hash values for “anchor” data blocks maintained adjacent to a middle map extent mapping to the data block which has been deduplicated (e.g., the middle map extent having a hash matching a hash of DB1) may be used to confirm this assumption by comparing the hash value maintained in the middle map for the “anchor” data block to hash values of DB2, DB3, DB4, and DB5. This works because the middle map extents are created sequentially for writes that occur.

Once operations 314 and 316 are complete for the “anchor” data block, workflow 300 is complete and the I/O requested for the data block received at operation 302 is fulfilled.

Referring back to operation 306, where VSAN module 108 determines a match for the hash is found in bloom filter 146 (e.g., a value of “true” is returned by bloom filter 146), VSAN module 108 determines the data block received at operation 302 (and corresponding to the hash) “might” or is “likely to” contain duplicated data. As mentioned previously, a value of “true” may be returned by bloom filter 146 where bits of the hash are likely to have been previously set in bloom filter 146.

Accordingly, at operation 318, to further confirm whether the data block received at operation 302 contains duplicated data (e.g., data which has already been stored in VSAN 116), VSAN module 108 looks for an entry in dedup hash table 148 with a partial hash matching a partial hash of the hash generated for the data block at operation 304. To perform such a lookup, at operation 318, VSAN module 108 may first locate a bucket in dedup hash table 148 which has bits matching a first subset of bits of the hash generated for the data block (e.g., locate a bucket created using less than all bits of the hash generated for the data block). As mentioned previously, buckets in dedup hash table 148 may store one or more dedup hash table entries and be based on a first subset of bits (e.g., one or more bits) of the hash value for each entry in the bucket.

After locating a bucket in dedup hash table 148, VSAN module 108, at operation 326, determines whether any entry in the identified bucket has a partial hash matching a partial hash of the hash generated for the data block at operation 304. A partial hash matches a partial hash of the hash generated for the data block when a same set of bits (e.g., the first three bits, the last ten bits, every other bit, etc.) of the hash associated with the entry used to create the partial hash for the entry in dedup hash table 148 are the same set of bits of the hash generated for the data block at operation 304 (e.g., the first three bits, the last ten bits, every other bit, etc.). In other words, VSAN module 108 determines whether any entry in the identified bucket has bits matching a second subset of bits of the hash (e.g., an entry with “matching bits”). An entry with “matching bits” may be an entry for a data block with data that is the same data requesting to be written to VSAN 116 for the data block received at operation 302. In certain embodiments, the second subset of bits of the hash used to find a matching entry in the bucket may be a greater number of bits of the hash as compared to the first subset of bits of the hash used to find a bucket in dedup hash table 148 (e.g., number of bits in the first subset of bits <number of bits in the second subset of bits). In certain embodiments, a number of bits of the second subset of bits of the hash may depend upon which bucket is located in dedup hash table 148, and further, how many entries are in the bucket. For example, where there are many entries in the located bucket, entries in the bucket may be stored with partial hashes having a greater number of bits to uniquely define each partial hash for each entry in the bucket. Thus, the number of bits of the second subset of bits may be greater to find a matching partial hash. The opposite may be true where the located bucket in dedup hash table 148 has few entries.

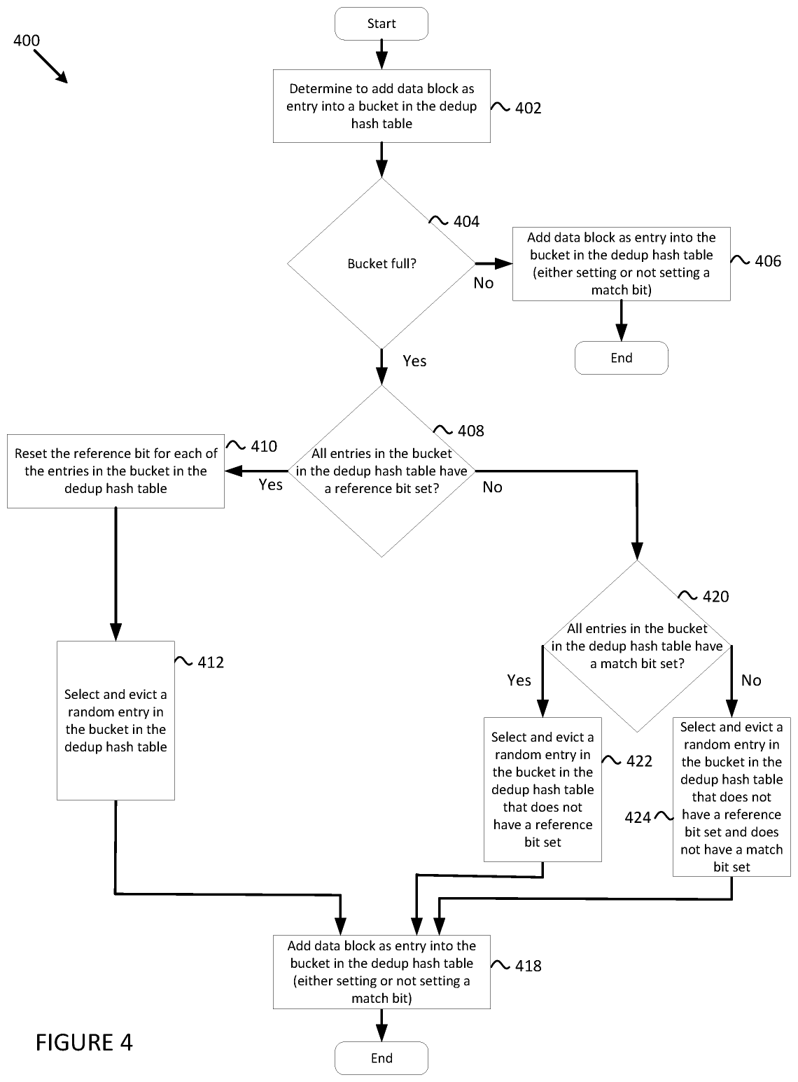

In some cases, VSAN module 108, at operation 326, determines that an entry with a partial hash matching the second subset of bits of the hash does not exist in the bucket. Multiple reasons may exist for why VSAN module 108 may not locate a bucket at operation 318 or an entry operation 326. For example, in some cases, this indicates that the data block received at operation 302 is for a write of the same data that has already been written as a data block to VSAN 116 but its hash has not been added to dedup hash table 148 (e.g., the second time this same data has been requested to be written to VSAN 116). In some other cases, this indicates that the data block received at operation 302 is for a write of the same data that has already been written as a data block to VSAN 116 and the hash of which was previously added as an entry in dedup hash table 148 and subsequently evicted (e.g., eviction of entries in dedup hash table 148 is described in more detail below with respect to FIG. 4). In some other cases, this indicates the data block received at operation 302 is for a write of data that has not already been written to VSAN 116 but was erroneously marked as having a hash found in bloom filter 146 (e.g., if the data block to be written is unique a value of “false” should have been returned by bloom filter 146 at operation 306). In either case, VSAN module 108 may not know which case corresponds to this data block. Accordingly, VSAN module 108 may not know whether this data block has been previously written to a PBA and a middle map extent pointing to this PBA exists (e.g., making this a duplicated data block) or whether this data block has not previously been written (e.g., making this a unique data block).

When an entry in a bucket is not found with bits matching the second subset of bits of the hash at operation 326, at operation 322, VSAN module 108 writes the data block to a physical block referenced by a PBA. Further, VSAN module 108 creates a new middle map extent with a monotonically increased MBA and adds an extent for the LBA of the data block in a logical map. The extent in the logical map may point to the new middle map extent in the middle map.

At operation 324, VSAN module 108 adds an entry in dedup hash table 148 corresponding to the data block. In certain embodiments, adding the entry in dedup hash table 148 includes adding the entry to a bucket in dedup hash table 148. In certain embodiments, the entry for the data block contains a tuple of <MBA, Partial Hash, Match Bit, Reference Bit>. The MBA in the tuple may correspond to the MBA which points to the PBA where the data block was written at operation 322. The partial hash in the tuple may correspond to the second subset of bits of the hash for the data block, where the subset of bits of the hash is less than all bits of the hash. In this case, the match bit in the entry may be set. Because this entry is added to dedup hash table 148 based on locating a hash of the data block in bloom filter 146, the match bit is set (e.g., match bit=1). Further, because this entry has not been deduplicated, the reference bit is not set (e.g., reference bit=0). Accordingly, the entry for the data block may contain a tuple of <MBA, Partial Hash, 1, 0>. Further, at operation 316, VSAN module 108 adds the hash for the data block (e.g., generated at operation 304) to the middle map extent created at operation 322. Although operation 316 is shown subsequent to operation 322 for purposes of illustration, operations 316 and 322 may be performed simultaneously such that the hash for the data block is added to the middle map extent when the middle map extent is created to avoid incurring additional I/O write costs needed to store the hash (e.g., leverage the existing write to the middle map). Further, at operation 316, a reference count in the middle map extent may be set to 1 and a match bit in the middle map extent may be set (e.g., match bit=1).

Once operations 322, 324, and 316 are complete for the data block, workflow 300 is complete and the I/O requested for the data block received at operation 302 is fulfilled.

Referring back to operation 326, in some cases, VSAN module 108 is able to locate a corresponding entry in a bucket in dedup hash table 148 with a partial hash matching a partial hash (e.g., the second subset of bits of the hash) for the data block received at operation 302. In this case, at operation 328, VSAN module 108 uses the MBA of the entry found in dedup hash table 148 to locate an extent in the middle map with an MBA equal to the entry. For example, the entry may contain a tuple of <MBA, Partial Hash, match bit, reference bit>; thus, VSAN module 108 may use the MBA of this tuple to locate a middle map extent having a tuple of <MBA, PBA> with a matching MBA.

After locating the middle map extent, at operation 330, VSAN module 108 compares a hash stored in the middle map for the middle map extent with the hash of the data block. In other words, VSAN module 108 performs a full hash comparison.

If at operation 330, the hash for the data block does not match the hash stored for the middle map extent, VSAN module 108 determines the data block needs to be written to storage. In particular, given the probabilistic nature of bloom filter 146 and because only a subset of bits of the hash were used to determine whether a hash match could be located in dedup hash table 148, in some cases (e.g., with low probability), the hash “matches” returned by bloom filter 146 and dedup hash table 148 were false positives. In other words, bloom filter 146 and dedup hash table 148 may determine a hash match exists when it does not.

Accordingly, at operation 322, VSN module 108 writes the data block to a physical block referenced by a PBA. Further, VSAN module 108 creates a new middle map extent with a monotonically increased MBA and adds an extent for the LBA of the data block in a logical map. The extent in the logical map may point to the new middle map extent in the middle map.

At operation 324, VSAN module 108 adds an entry in dedup hash table 148 corresponding to the data block. For this entry, the match bit is set (e.g., match bit=1). Further, because this entry has not been deduplicated, the reference bit is not set (e.g., reference bit=0). Accordingly, the entry for the data block may contain a tuple of <MBA, Partial Hash, 1, 0>. Further, at operation 316, VSAN module 108 adds the hash for the data block (e.g., generated at operation 304) to the middle map extent created at operation 320. As mentioned previously, although operation 316 is shown subsequent to operation 322 for purposes of illustration, operations 316 and 322 may be performed simultaneously such that the hash for the data block is added to the middle map extent when the middle map extent is created to avoid incurring additional I/O write costs needed to store the hash (e.g., leverage the existing write to the middle map). Further, at operation 316, a reference count in the middle map extent may be set to 1 and a match bit in the middle map extent may be set (e.g., match bit=1).

Once operations 322, 324, and 316 are complete for the data block, workflow 300 is complete and the I/O requested for the data block received at operation 302 is fulfilled.

On the other hand, if at operation 330, the hash for the data block does match the hash stored for the middle map extent, VSAN module 108 confirms the data block does, in fact, contain data which has previously been written to VSAN 116 (e.g., contains duplicated data). Accordingly, VSAN module 108 determines this data block needs to be deduplicaed.

After either operation 330, at operation 332, VSAN module 108 determines whether the match bit for the located entry in dedup hash table 148 (e.g., entry found, by VSAN module 108, in dedup hash table 148 at operation 328) is set. In particular, in some cases, the middle map entry found at operation 328 may be a middle map entry corresponding to an “anchor” data block. Thus, the middle map extent was created with a stored hash, not because the hash for the middle map extent was previously found in bloom filter 146, but because the data block associated with the hash qualified as an “anchor” data block under one or more policies set for the deduplication system. Accordingly, similar to operation 314, when an entry for this data block was added to dedup hash table 148 a match bit was not set (e.g., initialized with a met bit=0). However, now that a data block has been received which is a duplicate of the data block associated with the middle map extent, the entry maintained in dedup hash table 148 may be set. Such a scenario illustrates how adding hashes for “anchor” data blocks to middle map extents may help improve deduplication. In particular, by adding hashes for “anchor” data blocks, the likelihood of finding a deduplicable data block was increased in this scenario.

If at operation 332, the match bit for the located entry in dedup hash table 148 has not been set, at operation 338, the match bit for the located entry is set (e.g., match bit=1). Alternatively, if the match bit for the located entry in dedup hash table 148 has been set, no further action is needed regarding this bit.

Subsequently, at operation 340, VSAN module 108 adds an extent for the LBA of the data block in a logical map. The extent in the logical map may point to the middle map extent located at operation 328. At operation 342, VSAN module 108 increases a reference count maintained for the middle map extent in the middle map. In an example, if this is the second time an I/O request has been received to write data for this data block reference by the middle map extent, two logical map extents will be pointing to the middle map extent (e.g., after performing operation 340). Accordingly, the reference count may be increased such that the reference count equals two.

At operation 344, VSAN module 108 sets a reference bit maintained for the entry in dedup hash table 148 only where the reference bit has not been previously set. In a case where the reference bit was previously set (e.g., due to a previous deduplication), VSAN module 108 may not need to perform operation 344. Once operations 334, 340, 342, and 344 are complete for the data block, workflow 300 is complete and the I/O requested for the data block received at operation 302 is fulfilled.

As mentioned previously, hashes stored for “anchor” data blocks may be useful in determining whether neighboring (e.g., adjacent) middle map extents to a middle map extent having a hash which is determined to match a hash for a data block requested to be written (e.g., is determined to be a deduplicated hash/data block) are also deduplicated hashes. Accordingly, in some cases after operation 328 (although not shown), VSAN module 108 may use the located middle map extent to locate nearby middle map extents for “anchor” data blocks (e.g., middle map extents with hashes stored for “anchor” data blocks”). More specifically, VSAN module 108 may determine the MBA for the middle map extent having a hash that is used to deduplicate a data block and compare hash values stored in middle map extents for a threshold amount of MBAs less than or greater than the determined MBA. The stored hash values used for comparison may have been prior added to the middle map extents due to an “anchor” data block policy. As an illustrative example, VSAN module 108 may receive a request to write a payload of data to VSAN 116. VSAN module 108 may separate the payload to be written into five 4K data blocks (e.g., DB1, DB2, DB3, DB4, and DB5). As a first pass through workflow 300 of FIG. 3, VSAN module 108 may determine DB1 is a data block that has previously been written to VSAN 116 by locating a middle map extent, for example, corresponding to MBA10, with a hash matching a hash of the DB1. To determine whether DB2, DB3, DB4, and DB5 also contain data previously written to VSAN 116 (e.g., contain duplicated data), VSAN module 108 may determine whether hash values have been stored in middle map extents corresponding to MBA5-9 and/or MBA 11-14. In some cases, such middle map extents (e.g., MBA5-9 and MBA11-14) may have a hash stored due to the data blocks being associated with those middle map extents being “anchor” data blocks. Accordingly, VSAN module 108 may compare these stored hashes to hashes for DB2, DB3, DB4, and DB5 to determine whether these data blocks contain duplicated data. Where VSAN module 108 determines a hash stored matches a hash of DB2, DB3, DB4, or DB5, VSAN module 108 adds an entry to dedup hash table 148 for the data block with the matching hash. In certain embodiments, adding the entry to dedup hash table 148 includes not setting the match bit in the entry (e.g., match bit=0). By adding such entries to dedup hash table 148, the likelihood of determining a data block requested to be written contains duplicated data is increased.

As illustrated by workflow 300 of FIG. 3, each time a data block is requested to be written to VSAN 116, and more particularly, object store 118, more bits are set in bloom filter 146, and in some cases, more entries are added to dedup hash table 148. Accordingly, both bloom filter 146 and dedup hash table 148 may eventually become full (e.g., reach maximum capacity). Thus, aspects described herein further provide techniques for evicting entries from each of these structures. Further, techniques for recovering each of these structures are provided, as well.

FIG. 4 is an example workflow 400 for the eviction of entries maintained in the deduplication hash table structure, according to an example embodiment of the present application. Workflow 400 may be performed by VSAN module 108 illustrated in FIG. 1.

Workflow 400 begins at operation 402 by VSAN module 108 determining to add a data block as an entry into a bucket in dedup hash table 148. In particular, VSAN module 108 makes this determination prior to operations 314, 324, and 334 illustrated in FIG. 3. Accordingly, at operation 404, VSAN module 108 determines whether the selected bucket (e.g., selected based on the first subset of bits of the hash of the data block received at operation 302 in FIG. 3) is full. For example, buckets in dedup hash table 148 may each be allocated space in memory 114 that can contain a threshold number of entries. Where, at operation 404, the bucket is not full, VSAN module 108 adds an entry in the bucket in dedup hash table 148, the entry corresponding to the data block. The entry added to dedup hash table may include a match bit that is set (e.g., match bit=1) or a match bit that is not set (e.g., match bit=0).

Alternatively, where, at operation 404, the bucket is determined to be full, VSAN module 108 determines whether all entries in the bucket in dedup hash table 148 have a reference bit set. If all entries in the bucket have a reference bit set, at operation 410, VSAN module 108 resets the reference bit for each of the entries in the bucket. As an illustrative example, a bucket may be capable of holding eight entries. Where VSAN module 108 determines each of the eight entries has a reference bit equal to 1, VSAN module 108 resets the reference bit for each of the eight entries (e.g., such that reference bit=0). The assumption behind resetting all reference bits of entries in the bucket is that entries in the bucket which are frequently deduplicated are likely to have a reference bit re-set (e.g., such that reference bit=1) more quickly than an entry which is not frequently deduplicated. Accordingly, frequently deduplicated entries may have a reference bit set during the next eviction and be saved from eviction. Further, at operation 412, VSAN module 108 selects and evicts a random entry in the bucket

Eviction of an entry at operation 412 may make room in dedup hash table 148 for additional entries. Accordingly, at operation 418, VSAN module 108 adds an entry in the bucket in dedup hash table 148, the entry corresponding to the data block. The entry added to dedup hash table 148 may include a match bit that is set (e.g., match bit=1) or a match bit that is not set (e.g., match bit=0).

In some other cases, VSAN module 108, at operation 408, determines that one or more entries in the bucket in dedup hash table 148 do not have a reference bit set. Accordingly, at operation 420, VSAN module 108 determines whether all entries in the bucket in dedup hash table 148 (e.g., having either a reference bit=1 or a reference bit=0) have a match bit set.

If all entries in the bucket have a match bit set (e.g., the bucket is capable of holding eight entries and each of the eight entries has a match bit equal to 1), at operation 422, VSAN module 108 selects and evicts a random entry in the bucket that does not have a reference bit set (e.g., reference bit=0). On the other hand, if all entries in the bucket do not have a match bit set (e.g., the bucket is capable of holding eight entries and less than all of the eight entries has a match bit equal to 1), then at operation 424, VSAN module 108 selects and evicts a random entry in the bucket that does not have a match bit set (e.g., match bit=0) and does not have a reference bit set (e.g., reference bit=0). VSAN module 108 may be configured to evict an entry that does not have a match bit set, as this entry is less likely to be used for deduplication of a subsequent data block write given the entry was added to dedup hash table 148, not because of a deduplication, but because of an “anchor” data block policy. Further, VSAN module 108 may be configured to evict an entry that does not have a reference bit set, as this entry is less likely to be used for deduplication as compared to an entry which does have its reference bit set, thereby indicating that this entry has prior been deduplicated.

Eviction of an entry at either operation 422 or operation 424 may make room in dedup hash table 148 for additional entries. Accordingly, at operation 418, VSAN module 108 adds an entry in the bucket in dedup hash table 148, the entry corresponding to the data block. The entry added to dedup hash table may include a match bit that is set (e.g., match bit=1) or a match bit that is not set (e.g., match bit=0).

Although not illustrated in FIG. 4, in some cases prior to operation 410, VSAN module 108 determines whether the entry to be added to dedup hash table 148 is being added based on an “anchor” data block policy or is being added because a match for a hash of the data block was identified in bloom filter 146. Where VSAN module 108 determines the entry to be added to dedup hash table 148 is being added based on an “anchor” data block policy, VSAN module 104 may, in some cases, elect not to add this entry to dedup hash table 148. In particular, given all entries in the bucket have been previously used for deduplication (e.g., reference bit=1), VSAN module 108 may determine it is more beneficial to keep entries for these data blocks in dedup hash table 148, instead of removing a dedpulicated entry to add in an “anchor” data block entry that may not ever be used for deduplication.

Further, although example workflow 400 for eviction of entries is concerned with entries in a specific bucket in dedup hash table 148, in some other embodiments, operations of workflow 400 may be used to determine whether all entries in dedup hash table 148 have a reference bit set, whether all entries in dedup hash table 148 have a match bit set, and reset and/or evict entries based on all entries in dedup hash table 148 (as compared to only entries in one bucket in dedup hash table 148).

In some cases, a dedup hash table 148 may need to be recovered in memory 114 on a host 102 where dedup hash table 148 was previously stored or may need to be created (e.g., initiated) in memory 114 on another host 102 (e.g., where another host 102 storing the dedup hash table 148 in memory 114 has crashed, where a data object has moved, etc.). Creating or recovering dedup hash table 148 may include populating entries in dedup hash table 148 in memory 114.

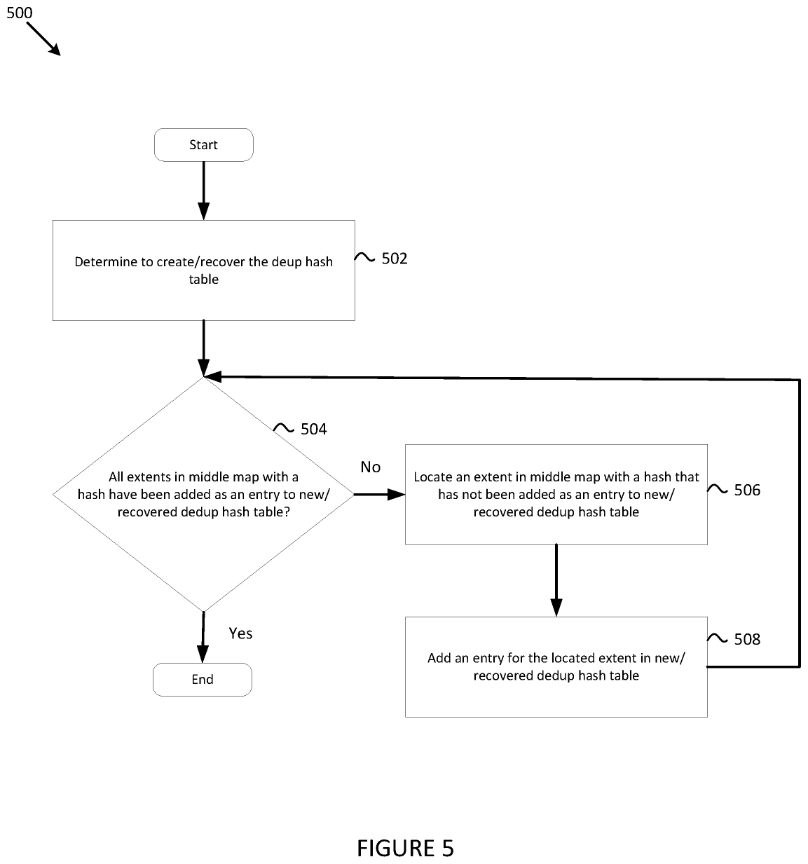

FIG. 5 is an example workflow 500 for populating entries in dedup hash table 148, according to an example embodiment of the present application. Workflow 500 may be performed by VSAN module 108 illustrated in FIG. 1.

Workflow 500 begins at operation 502 by VSAN module 108 determining to create/recover a dedup hash table 148 in memory 114 on a host 102. To create/recover dedup hash table 148 in memory 114, VSAN module 108 may iterate through middle map extents looking for extents which have a hash value stored. Where VSAN module 108 locates an extent with a stored hash, VSAN module 108 may create an entry for this middle map extent in dedup hash table 148. In certain embodiments, the entry added to dedup hash table 148 may contain a tuple of <MBA, Partial Hash, Match Bit, Reference Bit>. In particular, the MBA may be the MBA associated with the identified middle map extent. The partial hash may be generated based on a subset of bits (e.g., one or more bits) of the hash value stored in the middle map for the middle map extent. The match bit may be set (e.g., match bit=1) only where the match bit was previously set in the middle map extent. Where the match bit in the middle map extent was not previously set (e.g., match bit=0), the entry added to dedup hash table 148 may also not have a match bit set. The reference bit may not be set (e.g., reference bit=0). VSAN module 108 may perform such steps to add an entry to dedup hash table 148 for each middle map extent identified in the middle map having a stored hash.

For example, as illustrated in FIG. 5, at operation 504, VSAN module 108 may determine whether all extents in the middle map with a stored hash have been added as an entry in the new/recovered dedup hash table 148. If an entry for one or more extents in the middle map having a stored hash have not been added to the new/recovered dedup hash table 148, at operation 506, VSAN module 108 locates an extent in the middle map with a hash that has not been added as an entry to the new/recovered dedup hash table 148. Subsequently, at operation 508, VSAN module 108 adds an entry for the located extent in the new/recovered dedup hash table 148.

Operations 504-508 may repeat until VSAN module 108 determines, at operation 504, that all extents in the middle map with a stored hash have been added as an entry in the new/recovered dedup hash table 148. As described with respect to FIG. 3, only middle map extents for “anchor” data blocks and middle map extents for data blocks which are found in bloom filter 146 (e.g., prospective deduplicable hashes/entries) are stored with a hash. Accordingly, creation/recreation of dedup hash table 148 based on only middle map extents which contain a stored hash may provide dedup hash table 148 with entries that are likely to be used for deduplication.

In certain embodiments, using middle map extents with stored hash values to create/recover dedup hash table 148 in memory 114 may result in too many entries being created in dedup hash table 148 (e.g., where a large number of middle map extents having stored hash values exist). Accordingly, in certain embodiments, when creating/recovering dedup hash table 148, preference (e.g., for creating an entry) may be given to middle map extents having a stored hash value and having a match bit set (e.g., match bit=1).

Similar to dedup hash table 148, bloom filter 146 may also become full. For example, bloom filter 146 may become full due to large object writes and/or due to overwriting. Accordingly, bits of bloom filter 146 may need to be reset (e.g., periodically, occasionally, etc.) to clear bloom filter 146. According to certain aspects described herein, to subsequently recreate bloom filter 146, bits for each entry may be set in dedup hash table 148. In this way, bloom filter 146 may be repopulated with entries that are most likely to be deduplicated and serve their intended purpose in bloom filter 146 (e.g., to help identify potentially duplicated incoming write requests).

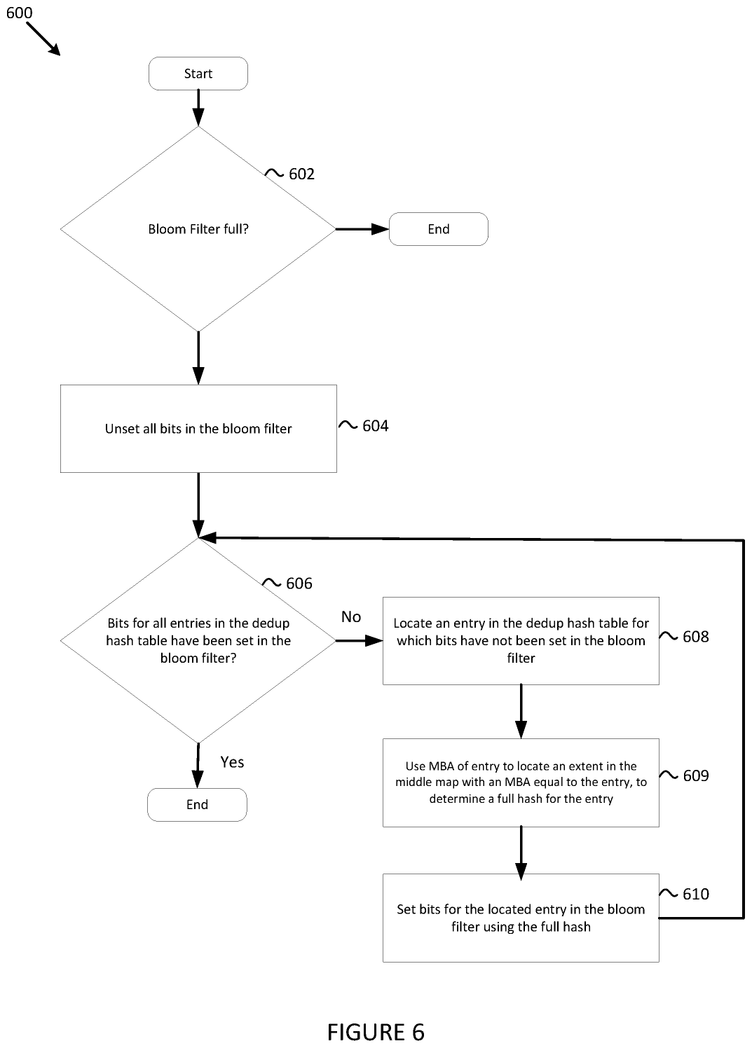

FIG. 6 is an example workflow 600 for the eviction and recovery of entries maintained in bloom filter 146, according to an example embodiment of the present application. As illustrated in FIG. 6, workflow 600 begin at operation 602 by determining whether bloom filter 146 is full (e.g., reached or is nearing maximum capacity). Where, bloom filter 146 is not full, no action is needed; however, where bloom filter 146 has reached, or is nearing, maximum capacity, at operation 604, bloom filter 146 is cleared. In certain embodiments, clearing bloom filter 146 includes unsetting all bits in bloom filter 146.

At operation 606, VSAN module 108 may determine whether all entries in dedup hash table 148 have been added as an entry (e.g., bits set) in bloom filter 146. If bits for one or more entries in dedup hash table 148 have not been set in bloom filter 146, at operation 608, VSAN module 108 locates an entry in dedup hash table 148 for which bits have not been set in bloom filter 146. Subsequently, at operation 609, VSAN module 108 uses the MBA of the entry located in dedup hash table 148 to locate an extent in the middle map with an MBA equal to the entry. For example, the entry may contain a tuple of <MBA, Partial Hash, match bit, reference bit>; thus, VSAN module 108 may use the MBA of this tuple to locate a middle map extent having a tuple of <MBA, PBA> with a matching MBA. VAN module 108 may locate the middle map extent to determine the full hash for the entry.

At operation 610, VSAN module 108 sets bits for the located entry in bloom filter 146 using the determined full hash. Operations 606-610 may repeat until VSAN module 108 determines, at operation 606, that bit have been set in bloom filter 146 for all entries in dedup hash table 148.

As an illustrative example, assuming bloom filter 146 has bits set for 80 data blocks (DB1-DB80) and is reaching capacity, VSAN module 108 may determine to clear the bloom filter (e.g., unset all bits). To recreate bloom filter 146 after it has been cleared, VSAN module 108 resets bits for each entry currently in dedup hash table 148. Dedup hash table 148 may contain entries for 10 data blocks. Accordingly, bloom filter 146 may be repopulated, or in other words, bits may be set, for these 10 data blocks. By repopulating bloom filter 146 using entries in dedup hash table 148, VSAN module 108 is more likely to find a matching entry in bloom filter 146 for subsequent requests to write data blocks to VSAN 116 compared to repopulating dedup hash table 148 with any subset of the 800 data blocks with bits originally set in bloom filter 146. Repopulating bloom filter 146 with entries from dedup hash table 148 may fill only a portion of bloom filter 146, thus leaving room for bits to be set for new hash values of data blocks requesting to be written to VSAN 116.

In some cases, repopulating bloom filter 146 with entries from dedup hash table 148 may cause low deduplication for a period of time until bits are set for hashes of incoming data block writes. Accordingly, in certain embodiments, bloom filter 146 may be separated into two parts such that workflow 600 may be independently performed for each part. As it's unlikely that both parts of bloom filter 146 will become full at the same time, workflow 600 may be performed for each part at separate times thereby avoiding a low deduplication situation given, at least half of bloom filter 146 remains intact. In such embodiments, each part of bloom filter 146 accommodates a different fixed range of hash values.

In certain embodiments, instead of a bloom filter 146, a counting quotient filter (CQF) may be alternatively used. In such embodiments, workflow 600 is not needed to evict and recover entries maintained in the CQF. In particular, the CQF is capable of resizing dynamically; thus, eviction and recovery operations illustrated in workflow 600 are not be necessary.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for inline block-level deduplication, the method comprising:
receiving a first input/output (I/O) to write a first data block in storage as associated with a first logical block address (LBA);
hashing the first data block corresponding to the first I/O to a first hash;
determining a match for the first hash is not contained in a bloom filter;
setting bits in the bloom filter for the first hash;
writing the first data block to a first physical block in the storage, the first physical block corresponding to a first physical block address (PBA);
adding a first middle map extent for the first PBA to a middle map, wherein the first middle map extent maps a first middle block address (MBA) to the first PBA; and
adding a first logical map extent for the first LBA to a logical map, wherein the first logical map extent maps the first LBA to the first MBA.

2. The method of claim 1, further comprising:
determining the first data block is an anchor data block based, at least in part, on a predetermined policy;
storing the first hash for the first data block, stored in the first PBA, in the first middle map extent based, at least in part, on the determination the first data block is an anchor data block; and
adding an entry for the first data block in a first deduplication hash table, the entry comprising at least a subset of bits of the first hash mapped to: the MBA, a match bit indicating the first data block is an anchor data block, and a reference bit indicating the first data block has not been duplicated.

3. The method of claim 2, further comprising:
receiving a second I/O to write the first data block in storage as associated with a second LBA;
hashing the first data block corresponding to the second I/O to the first hash;
determining a match for the first hash is contained in the bloom filter based on the set bits in the bloom filter for the first hash;
based on hashing the first data block corresponding to the second I/O to the first hash and determining the match for the first hash is contained in the bloom filter, determining the entry for the first data block is contained in the first deduplication hash table based on the subset of bits of the first hash;
locating the first middle map extent in the middle map based on the MBA included in the entry;
verifying the first hash corresponding to the second I/O matches the first hash stored in the middle map extent;
adding a second logical map extent for the second LBA to the logical map, wherein the second logical map extent maps the second LBA to the first MBA; and
increasing a reference count in the first middle map extent.

4. The method of claim 1, further comprising:
receiving a second I/O to write the first data block in the storage as associated with a second LBA;
hashing the first data block corresponding to the second I/O to the first hash;
determining a match for the first hash is contained in the bloom filter based on the set bits in the bloom filter for the first hash;
determining an entry for the first data block is not contained in a first deduplication hash table;
determining a middle map extent in the middle map with a stored hash equal to the first hash does not exist;
writing the first data block to a second physical block in the storage, the second physical block corresponding to a second PBA;
adding a second middle map extent for the second PBA to the middle map, wherein the second middle map extent maps a second MBA to the second PBA; and
adding a second logical map extent for the second LBA to the logical map, wherein the second logical map extent maps the second LBA to the second MBA.

5. The method of claim 4, further comprising:
storing the first hash for the first data block, stored in the second PBA, in the second middle map extent; and
adding an entry for the first data block in the first deduplication hash table, the entry comprising, at least, a subset of bits of the first hash mapped to: the second MBA and a match bit that is set.

6. The method of claim 5, further comprising:
evicting the entry for the first data block from the first deduplication hash table;
receiving a third I/O to write the first data block in the storage as associated with a third LBA;
hashing the first data block corresponding to the third I/O to the first hash;
determining a match for the first hash is contained in the bloom filter;
determining the entry for the first data block is not contained in the first deduplication hash table;
determining the first hash corresponding to the third I/O matches the first hash stored in the second middle map extent;
adding the entry for the first data block in the first deduplication hash table;
adding a third logical map extent for the third LBA to the logical map, wherein the third logical map extent maps the third LBA to the second MBA; and
increasing a reference count in the second middle map extent.

7. The method of claim 5, prior to adding the entry for the first data block in the first deduplication hash table, further comprising:
determining a bucket in the first deduplication hash table where the entry for the first data block is to be added, based, at least in part, on a second subset of bits of the first hash, the second subset of bits comprising a subset of the subset of bits of the first hash;
determining the bucket has reached a threshold capacity configured for the bucket;
determining whether each entry in the bucket has a reference bit set;
when the reference bit is set for each of the entries in the bucket:
resetting the reference bit for each of the entries in the bucket;
selecting a first entry among the entries in the bucket; and
evicting the first entry from the bucket; and
when the reference bit is not set for at least one entry in the bucket:
selecting a second entry among the at least one entry in the bucket with the reference bit not set; and
evicting the second entry from the bucket.

8. The method of claim 4, further comprising:
determining to recreate the first deduplication hash table as a second deduplication hash table; and
adding, for each middle map extent in the middle map with a stored hash, an entry in the second deduplication hash table, the entry comprising, at least, a subset of bits of the stored hash and an MBA associated with the middle map extent.

9. The method of claim 1, further comprising:
determining the bloom filter has reached a threshold capacity configured for the bloom filter;
unsetting all bits previously set in the bloom filter; and
resetting bits in the bloom filter for hashes associated with each entry in a first deduplication hash table.

10. A system comprising:
one or more processors; and
at least one memory, the one or more processors and the at least one memory configured to cause the system to:
receive a first input/output (I/O) to write a first data block in storage as associated with a first logical block address (LBA);
hash the first data block corresponding to the first I/O to a first hash;
determine a match for the first hash is not contained in a bloom filter;
set bits in the bloom filter for the first hash;
write the first data block to a first physical block in the storage, the first physical block corresponding to a first physical block address (PBA);
add a first middle map extent for the first PBA to a middle map, wherein the first middle map extent maps a first middle block address (MBA) to the first PBA; and
add a first logical map extent for the first LBA to a logical map, wherein the first logical map extent maps the first LBA to the first MBA.

11. The system of claim 10, wherein the one or more processors and the at least one memory are further configured to cause the system to:
determine the first data block is an anchor data block based, at least in part, on a predetermined policy;
store the first hash for the first data block, stored in the first PBA, in the first middle map extent based, at least in part, on the determination the first data block is an anchor data block; and
add an entry for the first data block in a first deduplication hash table, the entry comprising at least a subset of bits of the first hash mapped to: the MBA, a match bit indicating the first data block is an anchor data block, and a reference bit indicating the first data block has not been duplicated.

12. The system of claim 11, wherein the one or more processors and the at least one memory are further configured to cause the system to:
receive a second I/O to write the first data block in storage as associated with a second LBA;
hash the first data block corresponding to the second I/O to the first hash;
determine a match for the first hash is contained in the bloom filter based on the set bits in the bloom filter for the first hash;
based on hashing the first data block corresponding to the second I/O to the first hash and determining the match for the first hash is contained in the bloom filter, determine the entry for the first data block is contained in the first deduplication hash table based on the subset of bits of the first hash;
locate the first middle map extent in the middle map based on the MBA included in the entry;
verify the first hash corresponding to the second I/O matches the first hash stored in the middle map extent;
add a second logical map extent for the second LBA to the logical map, wherein the second logical map extent maps the second LBA to the first MBA; and
increase a reference count in the first middle map extent.

13. The system of claim 10, wherein the one or more processors and the at least one memory are further configured to cause the system to:
receive a second I/O to write the first data block in the storage as associated with a second LBA;
hash the first data block corresponding to the second I/O to the first hash;
determine a match for the first hash is contained in the bloom filter based on the set bits in the bloom filter for the first hash;
determine an entry for the first data block is not contained in a first deduplication hash table;
determine a middle map extent in the middle map with a stored hash equal to the first hash does not exist;
write the first data block to a second physical block in the storage, the second physical block corresponding to a second PBA;
add a second middle map extent for the second PBA to the middle map, wherein the second middle map extent maps a second MBA to the second PBA; and
add a second logical map extent for the second LBA to the logical map, wherein the second logical map extent maps the second LBA to the second MBA.

14. The system of claim 13, wherein the one or more processors and the at least one memory are further configured to cause the system to:
store the first hash for the first data block, stored in the second PBA, in the second middle map extent; and
add an entry for the first data block in the first deduplication hash table, the entry comprising, at least, a subset of bits of the first hash mapped to: the second MBA and a match bit that is set.

15. The system of claim 14, wherein the one or more processors and the at least one memory are further configured to cause the system to:
evict the entry for the first data block from the first deduplication hash table;
receive a third I/O to write the first data block in the storage as associated with a third LBA;
hash the first data block corresponding to the third I/O to the first hash;
determine a match for the first hash is contained in the bloom filter;
determine the entry for the first data block is not contained in the first deduplication hash table;
determine the first hash corresponding to the third I/O matches the first hash stored in the second middle map extent;
add the entry for the first data block in the first deduplication hash table;
add a third logical map extent for the third LBA to the logical map, wherein the third logical map extent maps the third LBA to the second MBA; and
increase a reference count in the second middle map extent.

16. The system of claim 14, prior to adding the entry for the first data block in the first deduplication hash table, wherein the one or more processors and the at least one memory are further configured to cause the system to:
determine a bucket in the first deduplication hash table where the entry for the first data block is to be added, based, at least in part, on a second subset of bits of the first hash, the second subset of bits comprising a subset of the subset of bits of the first hash;
determine the bucket has reached a threshold capacity configured for the bucket;
determine whether each entry in the bucket has a reference bit set;
when the reference bit is set for each of the entries in the bucket:
reset the reference bit for each of the entries in the bucket;
select a first entry among the entries in the bucket; and
evict the first entry from the bucket; and
when the reference bit is not set for at least one entry in the bucket:
select a second entry among the at least one entry in the bucket with the reference bit not set; and
evict the second entry from the bucket.

17. The system of claim 13, wherein the one or more processors and the at least one memory are further configured to cause the system to:
determine to recreate the first deduplication hash table as a second deduplication hash table; and
add, for each middle map extent in the middle map with a stored hash, an entry in the second deduplication hash table, the entry comprising, at least, a subset of bits of the stored hash and an MBA associated with the middle map extent.

18. The system of claim 10, wherein the one or more processors and the at least one memory are further configured to cause the system to:
determine the bloom filter has reached a threshold capacity configured for the bloom filter;
unset all bits previously set in the bloom filter; and
reset bits in the bloom filter for hashes associated with each entry in a first deduplication hash table.

19. A non-transitory computer-readable medium comprising instructions that, when executed by one or more processors of a computing system, cause the computing system to perform operations for inline block-level deduplication, the operations comprising:
receiving a first input/output (I/O) to write a first data block in storage as associated with a first logical block address (LBA);
hashing the first data block corresponding to the first I/O to a first hash;
determining a match for the first hash is not contained in a bloom filter;
setting bits in the bloom filter for the first hash;
writing the first data block to a first physical block in the storage, the first physical block corresponding to a first physical block address (PBA);
adding a first middle map extent for the first PBA to a middle map, wherein the first middle map extent maps a first middle block address (MBA) to the first PBA; and
adding a first logical map extent for the first LBA to a logical map, wherein the first logical map extent maps the first LBA to the first MBA.

20. The non-transitory computer-readable medium of claim 19, wherein the operations further comprise:
determining the first data block is an anchor data block based, at least in part, on a predetermined policy;
storing the first hash for the first data block, stored in the first PBA, in the first middle map extent based, at least in part, on the determination the first data block is an anchor data block; and
adding an entry for the first data block in a first deduplication hash table, the entry comprising at least a subset of bits of the first hash mapped to: the MBA, a match bit indicating the first data block is an anchor data block, and a reference bit indicating the first data block has not been duplicated.
